(19) United States
(12) Patent Application Publication
(10) Pub. No.: US 2009/0098937 A1
(43) Pub. Date: Apr. 16, 2009

(54) ADAPTIVE TREE VISUALIZATION FOR TOURNAMENT-STYLE BRACKETS

(75) Inventors: Desney S. Tan, Kirkland, WA (US); Gregory R. Smith, Bellevue, WA (US); Bongshin Lee, Issaquah, WA (US); George G. Robertson, Seattle, WA (US)

Correspondence Address: MICROSOFT CORPORATION;C/O LYON & HARR, LLP, 300 ESPLANADE DRIVE, SUITE 800, OXNARD, CA, 93036, US

(73) Assignee: Microsoft Corporation, Redmond, WA (US)

(21) Appl. No.: 11/871,924

(22) Filed: Oct. 12, 2007

(51) Int. Cl. A63F 13/00

(52) U.S. Cl. 463/31

(57) ABSTRACT

An adaptive tree visualization system and method for adaptively deforming a traditional bracket tree to visualize information about competitors in a linear manner. A one-dimensional result line emanates from the name of each competitor such that the progress of each competitor can be immediately determined by examining the length of the competitor's result line. The result line typically is composed of multiple result line segments. Each line segment spans a particular time period column to indicate that the competitor is matched up with another competitor during that time period. A pending result line segment spans the adjacent time period to indicate that the results of the match-up are unknown. Once the result of the match-up is known, the pending result line is added to the result line segment of the winning competitor. This extends the winner's result line into the next time period while the loser's result line remains unchanged.

### BACKGROUND

A traditional bracket visualization is used to visualize a tournament structure. As used in this document, a tournament refers to a number of competitors from a single sport (or other domain of competition) vying to be crowned the overall champion. Depending on the particular tournament, a competitor can refer to a single person (such as an athlete or contestant) or a group of people (such as a sports team). Each tournament consists of a series of head-to-head contests (sometimes referred to as matches, ties, fixtures, or heats) between competitors that leads to some result, such as one competitor winning the contest. In a single elimination tournament (also known as a knockout or sudden-death tournament), competitors who lose a match are immediately eliminated from the tournament (or at least from winning the tournament). Only winning competitors are able to progress and vie to be the tournament champion.

Because the basic goal of a tournament is to winnow multiple competitors down to a single champion, a useful visual representation is a tree or hierarchy. A bracket is a common term for a tree-based tournament visualization. The structure of the bracket defines how and when competitors will play each other as they progress through the tournament towards the championship.

FIG. 1 illustrates a traditional tournament bracket 100. This bracket structure 100 contains a series of match-ups, which, as shown in FIG. 1, has teams playing each other connected by a vertical line. Each team is matched up against another team and the structure of the bracket 100 is well defined such that there is a fixed progression of teams throughout the bracket 100. As shown in FIG. 1, the bracket 100 includes 5 rounds starting with “Round 1” and progressing to the “Winner.” For ease in illustrating these rounds, a dashed line has been placed between each round to delineate the rounds. It should be noted that these dashed lines are not part of the traditional tournament bracket 100 but are merely shown for convenience.

The winner of each match-up progresses to the next round and their name is filled in on a result line, which comes out of the match-up. This forms a new match-up with another team, and this process continues until there is only one team left (the tournament winner). By way of example and not limitation, the bracket 100 shown in FIG. 1 illustrates that Duke has played and beat Southern U. in Round 1. This means that Duke's name is placed on the result line in Round 2. In addition, G. Washington has played and beat UNC Wilmington in Round 1, so that G. Washington's name is placed on the result line in Round 2. This creates a match-up between Duke and G. Washington in Round 2. This process continues until the Finals, where LSU played Texas. As can be seen from FIG. 1, LSU won the tournament and this result is illustrated in the “Winner” round on the far right of FIG. 1. It should be appreciated that there exist many variants of the bracket visualizations, but these basic properties hold.

The traditional bracket visualization 100 has at least two disadvantages and undesirable properties. First, it is difficult for a user to track a particular team's progress on a traditional bracket 100 since the path of any given team goes through arbitrary up and down offsets with each round. For example, referring to FIG. 1, if a user wants to track how Texas did in the tournament, the user must follow Texas first down, then up, then up farther as it progresses horizontally across bracket 100. This makes it difficult to track a single team in which the user is interested.

Another disadvantage of the traditional bracket 100 is that it occupies a significant amount of horizontal space. Since names of tournament competitors are repeated for each round that the competitors progress, traditional bracket 100 has to allocate sufficient space in every round to hold the longest name of all the competitors that may potentially reach that round. The reason for this is that the traditional bracket 100 originally was designed for use on static media such as paper. As games are played and real-world results are tallied on bracket 100, updating the bracket merely required that winning teams be inserted into the bracket. There is never a need to delete or change any existing content or structure. While this incrementally additive updating is advantageous, even critical, for static media (such as paper), with the advent of dynamic media (such as computer displays) it is desirable to take advantage of the ability to re-render information in order to optimally present the available information at each point in time.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The adaptive tree visualization system and method include adaptively deforming a traditional bracket tree to visualize information about competitors in a linear manner. The name of each competitor in an event is written only once, and the outcome information and results of a match-ups between competitors during different time periods of the event is shown linearly emanating from the competitor's name. Thus, the traditional bracket tree is adaptively deformed to a one-dimensional result line for each competitor.

The progress of each competitor can be determined by the length of the competitor's result line. In general, the longer the result line the better the competitor is performing in the event, since the result line is made longer each time the competitor wins a match-up during a time period. This linear deformation allows the competitor's name to be written only once, thereby saving space. In addition, the progress of a competitor can be ascertained quickly and efficiently by simply looking for a competitor's name and comparing the length of its result line to the result lines of other competitors.

Generally, the adaptive tree visualization system represents changes over time of constituents of the system. The system includes a time component in a first direction, having multiple discrete time periods, and a constituent component in a second direction. The first direction and the second direction are orthogonal to each other. The system includes n inputs or constituents and m outputs, where n is greater than or equal to m. The system also includes a one-dimensional result line for each of the constituents that is oriented in the first direction. It can be seen by looking at the length of each constituent's result line whether that constituent is one of the m outputs of the system. The single-elimination tournament described above is an instance of this generalization where n is 2 and m is 1, the constituent components are competitors in a tournament, and each discrete time period is a round of competition.

The result lines typically are composed of multiple result line segments. Each result line segment spans a particular time period column to indicate that the constituent is present in the visualization during that time period as a “result” either of the initial conditions or of a prior matchup. Match-up bars in the second direction are used to connect the result line segments of those constituents that are matched up. A pending result line segment spans the adjacent subsequent time period to indicate that the results of the match-up are currently unknown. Once the result of the match-up is known, the pending result line is added to the result line segment of the winning constituent. This extends the length of the winner's result line into the next time period while the loser's result line remains unchanged.

The adaptive tree visualization system can be used for tournament-style brackets. Rather than repeating competitor names on a static tournament bracket to indicate wins in each match-up, the system moves the pending result line segment up or down from a match-up to extend the result line of the winning competitor. A competitor's progress through the tournament is represented by a single, one-dimensional result line extending from its name through the different time periods. When a competitor loses, its result line terminates, since the pending result line segment that could have been used to extend the losing competitor's line in the next round has moved to extend the winning competitor's line instead.

The system also uses line color, line thickness, line type, and line boldness to make the visualization even clearer. For example, names of competitors and associated lines can be grayed out when competitors lose. Moreover, unplayed match-up lines and result line segments can be represented as dotted lines. These dotted lines can be rounded rather than bracket shaped to make them more distinct.

Information overlays can be used to convey additional information for each competitor. By way of example, statistics such as the likelihood of a team to reach various rounds in the tournament, or the percentage of players in an office pool that have picked a certain team to get to each of the rounds can be included in an overlay. In addition, an overlay containing the picks of a player can be used to compare a player's pick of who will win with the real-world results. In some embodiments an underlay is used to define the player's picks. Each line segment where the pick matches the real-world outcome is turned a first color and each segment where the pick does not match (or is eliminated from consideration due to a prior loss) is turned a second color. This information also can be dual encoded, such that the information can not only be represented by line color but also by line shape or line type.

A player can interact with the system by clicking on various information links within the visualization to bring up information about the competitor or team, statistics from a particular game (past, present, or future), or other relevant information content. The player can also make selections (or picks) to predict which competitors the player thinks will win. For example, the player can click on a competitor's name to indicate that the particular competitor wins a game. Each click indicates a single win, and players can do this for each contest in the tournament. In alternate embodiments, the player drags competitor's names into or within the system. For example, rather than clicking on a competitor twice in order to indicate that it wins two contests, the player could just drag the competitor name past the second round to indicate that it is picked to win all contests through the round on which it has been dropped.

The method of the adaptive tree visualization system includes adapting a shape of a tournament bracket tree to visualize results from a competition. The method defines rows of competition competitors and columns of rounds of match-ups. Each competitor is listed in its own row. Moreover, each competitor is listed in an order such that competitors that play each other in the first round are adjacent. Result line segments are drawn for each of the competitors. The result line segments of those competitors competing against each other in the first round are connected by a match-up bar. A pending result line segment is drawn in the second column (representing the second round of competition) bisecting the match-up bar. When a competitor wins a match-up the first round, the pending result line segment is added to the winner's result line. This extends the winner's result line to the next round, while the loser's result line does not increase in length.

It should be noted that alternative embodiments are possible, and that steps and elements discussed herein may be changed, added, or eliminated, depending on the particular embodiment. These alternative embodiments include alternative steps and alternative elements that may be used, and structural changes that may be made, without departing from the scope of the invention.

### DRAWINGS DESCRIPTION

Referring now to the drawings in which like reference numbers represent corresponding parts throughout:

FIG. 1 illustrates a traditional tournament bracket.

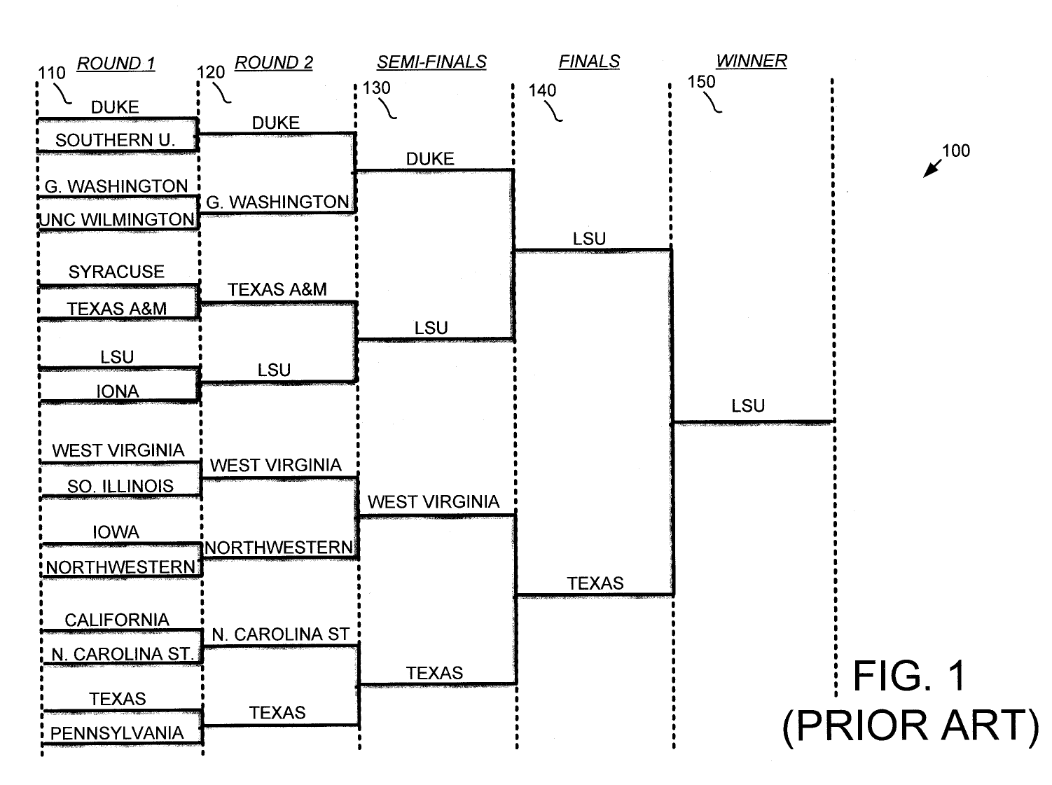

FIG. 2 is a block diagram illustrating a general overview of the adaptive tree visualization system disclosed herein.

FIG. 3 illustrates an exemplary example of the adaptive tree visualization system shown in FIG. 2 before the tournament.

FIG. 4 illustrates an exemplary example of the tournament adaptive tree shown in FIG. 3 after Round 1 of the tournament.

FIG. 5 illustrates an exemplary example of the tournament adaptive tree shown in FIGS. 3 and 4 after a portion of Round 2 of the tournament has been completed.

FIG. 6 illustrates an exemplary example of the tournament adaptive tree shown in FIGS. 3-5 at the end of the tournament.

FIG. 7 is a compact tournament adaptive tree, which is a compact version of the tournament adaptive tree shown in FIGS. 3-6.

FIG. 8 illustrates an alternate embodiment of the tournament adaptive tree shown in FIGS. 3-6.

FIG. 9 illustrates various overlays that can be applied to the tournament adaptive tree shown in FIGS. 3-6 for single player's picks.

FIG. 10 is a flow diagram illustrating the general operation of the method used in the adaptive tree visualization system shown in FIGS. 2-9.

FIG. 11 illustrates an example of a suitable computing system environment in which the adaptive tree visualization system and method shown in FIGS. 2-10 may be implemented.

### DETAILED DESCRIPTION

In the following description of the adaptive tree visualization system and method reference is made to the accompanying drawings, which form a part thereof, and in which is shown by way of illustration a specific example whereby the adaptive tree visualization system and method may be practiced. It is to be understood that other embodiments may be utilized and structural changes may be made without departing from the scope of the claimed subject matter.

### I. Adaptive Tree Visualization Overview

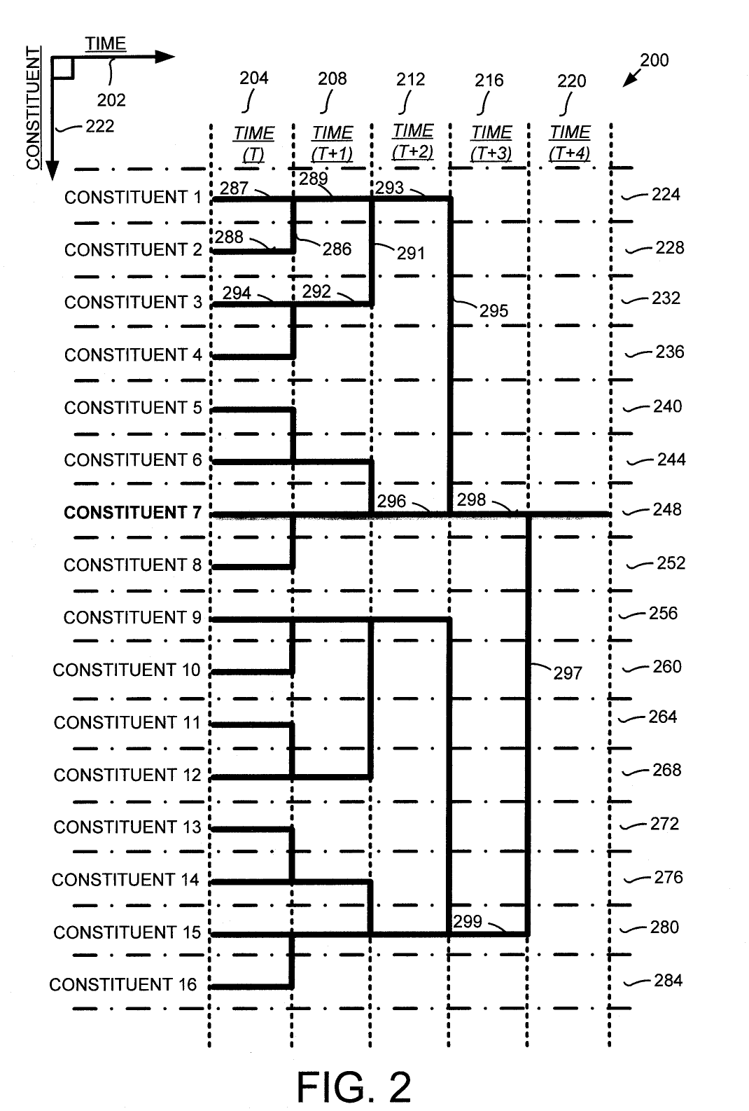

The adaptive tree visualization system and method mitigates the problems imposed by traditional brackets by deforming the traditional bracket representation of a tree and using its shape to convey outcome information at each time period of an event (such as a tournament). FIG. 2 is a block diagram illustrating a general overview of the adaptive tree visualization system 200 disclosed herein. It should be noted that the exemplary implementation shown in FIG. 2 is only one of many implementations that are possible.

In general, the adaptive tree visualization system 200 shown in FIG. 2 visualizes an event (such as a tournament) using two orthogonal components. A first component is a time component 202, where the time is shown increasing in the direction of the arrow. In the exemplary embodiment shown in FIG. 2, the time component is shown in columns and increasing from left to right. For example, the time component 202 is shown in FIG. 2 as column, where time increases from the first column 204 (Time (T)), to the second column 208 (Time (T+1)), to the third column 212 (Time (T+2)), to the fourth column 216 (Time(T+3)), to the fifth column 220 (Time(T+4)). It should be noted that although only five columns of the time component 202 are illustrated, in specific embodiments greater or fewer columns may be used.

A second component is a constituent component 222, which is illustrated as rows in FIG. 2. The constituent component 222 contains a listing of constituents or competitors in the event. The n constituents are the n inputs to the system 200. The system 200 also has m outputs, where n is greater than or equal to m (n>m). Although the system 200 of FIG. 2 has only a single output, represented by a single winner (Constituent 7), in other embodiments of the system 200 there may be more than one output. Similarly, each match-up between constituents within system 200 of FIG. 2 has two constituent inputs and one constituent output, but in general any match-up can consist of n constituent inputs and m constituent outputs.

As shown in FIG. 2, the adaptive tree visualization system 200 contains a plurality of rows such that each constituent has a separate row. For example, Constituent 1 is shown in a first row 224, Constituent 2 is shown in a second row 228, Constituent 3 is shown in a third row 232, Constituent 4 is shown in a fourth row 236, Constituent 5 is shown in a fifth row 240, Constituent 6 is shown in a sixth row 244, Constituent 7 is shown in a seventh row 248, Constituent 8 is shown in a eighth row 252, Constituent 9 is shown in a ninth row 256, Constituent 10 is shown in a tenth row 260, Constituent 11 is shown in a eleventh row 264, Constituent 12 is shown in a twelfth row 268, Constituent 13 is shown in a thirteenth row 272, Constituent 14 is shown in a fourteenth row 276, Constituent 15 is shown in a fifteenth row 280, and Constituent 16 is shown in a sixteenth row 284. It should be noted that although sixteen rows of the constituent component 222 are illustrated, greater or fewer rows may be used depending on the actual number of constituents and the specific embodiment.

As noted above the time component 202 and the constituent component 222 are orthogonal. This is shown in the upper left side of FIG. 2. In the exemplary embodiment shown in FIG. 2, the time component 202 is oriented in the horizontal direction with time increasing from left to right and the constituent component 222 is oriented in the vertical direction in ascending order from top to bottom. However, in some embodiments of the adaptive tree visualization system 200 the orientation of the time component 202 and the constituent component 222 may be oriented differently from that shown in FIG. 2. For example, in some embodiments the time component 202 may be in the vertical direction, in some embodiments the time component 202 may increase going from top to bottom, while in other embodiments the time component may increase going from bottom to top. In some embodiments the constituent component 222 may be in the horizontal direction, with the constituents listed in ascending order from left to right, while in other embodiments the constituents may be listed in ascending order from right to left. Moreover, it is not necessary for the adaptive tree visualization system 200 to be oriented such that the components are exactly lined up with the vertical and horizontal directions. In some embodiments the adaptive tree visualization system 200 may be skewed with respect to the vertical and horizontal directions. However, the time component 202 and the constituent component 222 will remain orthogonal to each other.

FIG. 2 also includes overlaid vertical lines (shown as dotted lines) and overlaid horizontal lines (shown as alternating dots and dashes). These overlaid lines are not part of the adaptive tree visualization system 200, but are merely provided as an aid in delineating the rows and columns of the system 200.

The system 200 of FIG. 2 represents an event that has occurred. It can be seen that the event contained sixteen constituents and included five time periods. The solid, dark lines are part of the system 200 and represent information associated with the event. For example, the solid, dark lines in the direction of the time component 202 represent the match-ups between constituents and the results of these match-ups. The solid, dark line in the direction of the constituent component 222 represents the match-ups between constituents.

By way of example, by looking down the first column 204 (Time(T)) in FIG. 2 it can be seen from the solid, dark horizontal lines that each of the constituents was involved in the match-ups that occurred at Time (T). Note that this example line segment will be denoted as line segment_{x,y}, where x represents a constituent number and y represents a column number. Thus, line segment_{1,2} means that the line segment is for Constituent 1 and spans the width of column 2 at the position of Constituent 1. The result lines of each of the constituents typically will be composed of multiple result line segments, the length of which depends on how the constituent performs during each time period.

In this example, a first match-up bar 286, which is represented by a solid, dark vertical line, indicates that one of the match-ups at Time (T) was between Constituent 1 and Constituent 2. The first match-up bar 286 is between a result line segment_{1,1} 287 and a result line segment_{2,1} 288. This first match-up bar 286 indicates that Constituent 1 and Constituent 2 were matched-up at Time (T). Further, by looking at the second column 208 (Time(T+1)) it can be seen that the match-up between Constituent 1 and Constituent 2 at Time(T) was won by Constituent 1. This is because Constituent 1's result line segment_{1,1} 287 is lengthened into the second column 208 by a result line segment_{1,2} 289. Moreover, Constituent 2's result line segment_{2,1} 288 does not extend into the second column 208 but stops at the first column 204.

The next match-up for Constituent 1 is shown by a second match-up bar 291 between Constituent 1's result line segment_{1,2} 289 and Constituent 3's result line segment_{3,2} 292. This indicates that there is a match-up between Constituent 1 and Constituent 3 that occurred during time period shown by the second column 208 (Time(T+1)). By looking at the third column 212 (Time(T+2)), it can be seen that match-up between Constituent 1 and Constituent 3 at Time(T+1) was won by Constituent 1. Again, this is because Constituent 1's result line, which includes result line segment_{1,1} 287 and result line segment_{1,2} 289 is extended into the third column 212 to include result line segment_{1,3} 293. Moreover, Constituent 3's result line, which includes a result line segment_{3,1} 294 and the result line segment_{3,2} 292 does not extend past the second column 208.

Similarly, the next match-up for Constituent 1 is shown by a third match-up line between Constituent 1's result line segment_{1,3} 293 and Constituent 7's result line segment_{7,3} 296. This indicates a match-up between Constituent 1 and Constituent 7 during Time(T+2) shown in the third column 212. By examining the fourth column 216 at Time(T+3), it can be seen that the match-up between Constituent 1 and Constituent 7 during Time(T+2) was won by Constituent 7. This is because Constituent 7's result line extends into the fourth column 216 with line segment_{7,4} 298, while Constituent 1's result line (which now includes result line segment_{1,1} 287, result line segment_{1,2} 289, and result line segment_{1,3} 293) does not extend past the third column 212.

At this point Constituent 1 has no more match-ups. However, the next match-up for Constituent 7 is shown by a fourth match-up bar 297 between Constituent 7's result line segment_{7,4} 298 and Constituent 15's result line segment_{15,4} 299. This is indicative of a match-up between Constituent 7 and Constituent 15 occurring during Time(T+3) shown in the fourth column 216. By looking at the fifth column 220 at Time(T+4) it can be seen that the match-up between Constituent 7 and Constituent 15 was won by Constituent 7. This is because Constituent 7's result line extends into the fifth column 220, while Constituent 15's result line segment_{15,4} 299 stops at the fourth column 216. At this point, it can be seen that Constituent 7 is the winner of the event, since Constituent 7's result line extends in the horizontal direction further than the horizontal lines of the other constituents.

It should be noted that the adaptive tree visualization system 200 allows a user (not shown) to quickly find results and information about a particular constituent. For example, if a user is interested in how Constituent 3 did in the event, all the user needs to do is to find Constituent 3's result line (consisting of the result line segment_{3,1} 294 plus the result line segment_{3,2} 292) and scan across the row. The user can quickly find and absorb a multitude of information about Constituent 3. Specifically, the user can find out that Constituent 3 lost the match-up that occurred during Time(T+1), that match-up was with Constituent 1, and that Constituent 3 won the match-up with Constituent 4 in that occurred at Time(T). Moreover, the user can see that Constituent 7 won the event by scanning Constituent 7's result line. In addition, Constituent 7's name is bolded to further indicate that Constituent 7 won the event.

The system 200 requires that constituents' names be printed only once. In addition, as compared to the traditional bracket 100, the staggered lines in the horizontal direction for a traditional bracket 100 are collapsed into a single line in the direction of the time component 202. In the case shown in FIG. 2, this is the horizontal direction. Thus, the information is collapsed into a single, one-dimensional line instead of the two-dimensional line of the traditional bracket 100. This means that the user merely needs to scan in a straight line with a constituent's name to quickly ascertain how each constituent is doing or did in the event.

### II. Adaptive Tree Visualization Details

Additional details of the adaptive tree visualization system 200 will be illustrated by using an exemplary example. While the following discussion of the adaptive tree visualization system and method is in the context of pick-em games and tournament-style brackets, it should be noted that any domain having brackets and trees of this form could utilize the system and method discussed herein.

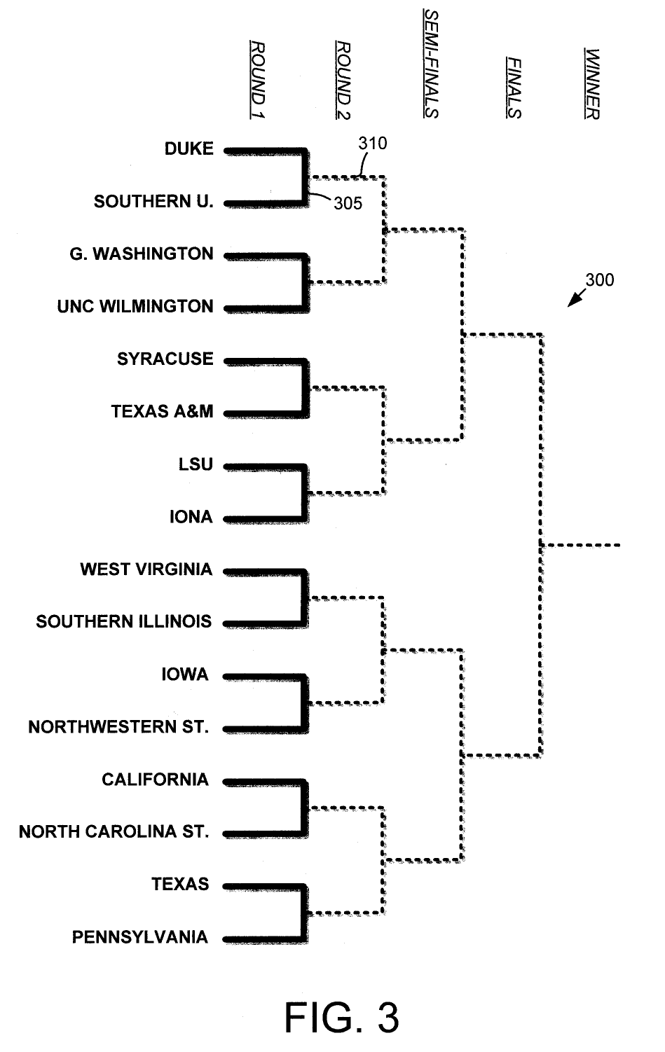

In particular, FIGS. 3-9 illustrate a tournament adaptive tree 300 that is one embodiment of the adaptive tree visualization system 200 shown in FIG. 2. In this exemplary example of FIGS. 3-9, the competitors are college basketball teams and the time periods are rounds in a tournament. It should be noted that in other embodiments of the adaptive tree visualization system 200 the visualization can be mirrored. This means that left to right can also be used right to left. For example, for a 64-team brackets there are 32 teams on each side of the bracket such that the visualization is mirrored.

FIG. 3 illustrates an exemplary example of the adaptive tree visualization system 200 shown in FIG. 2 before the tournament. As can be seen from FIG. 3, at this stage of the tournament (before the tournament has begun) the tournament adaptive tree 300 looks similar to the traditional bracket 100. However, there are several differences to note. Specifically, the team names are located on the outside of the tree 300 and the games that are scheduled for the current round are shown as solid lines while the future games are shown in dotted lines. In this case, the solid, dark vertical lines indicate which teams will be playing each other in Round 1. For example, in Round 1 the first solid, dark vertical line 305 indicates that Duke is playing Southern U. in Round 1. In some embodiments, the initial lines connecting teams could also be shorter than the rest of the lines, to indicate that these are not actually results of prior match-ups, but rather the initial tournament configuration.

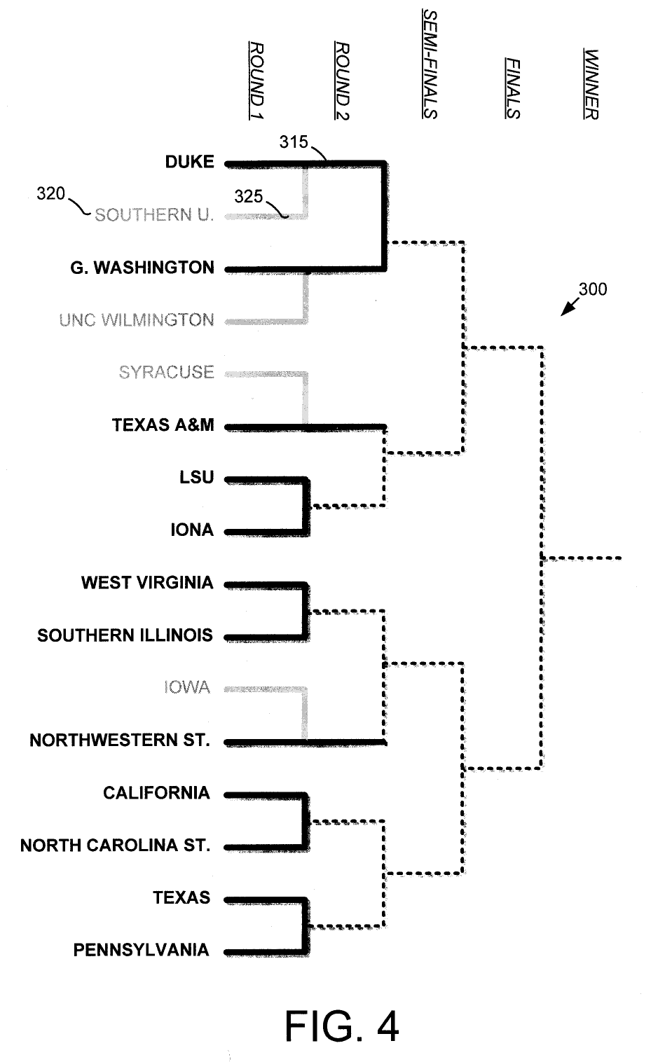

FIG. 4 illustrates an exemplary example of the tournament adaptive tree 300 shown in FIG. 3 after a portion of Round 1 of the tournament. As games are played, the tournament adaptive tree 300 adapts or deforms itself to represent the state of the tournament. Horizontal lines move or deform from the center of a match-up to extend the horizontal line from the winning team. For example, the horizontal line 310 (in FIG. 3) from the Duke-Southern U. game in Round 1 is adapted or deformed to extend Duke's horizontal line 315 (in FIG. 4) into Round 2. This indicates that Duke won the game. Moreover, the losing teams are grayed out and their horizontal lines are not extended. By way of example, because Southern U. lost the game, its name is grayed out 320 and Southern U's horizontal line 325 is not extended past Round 1. Moreover, Southern U's horizontal line 325 and the first solid, dark vertical line 305 also are grayed out. The dotted lines indicating future games are updated accordingly.

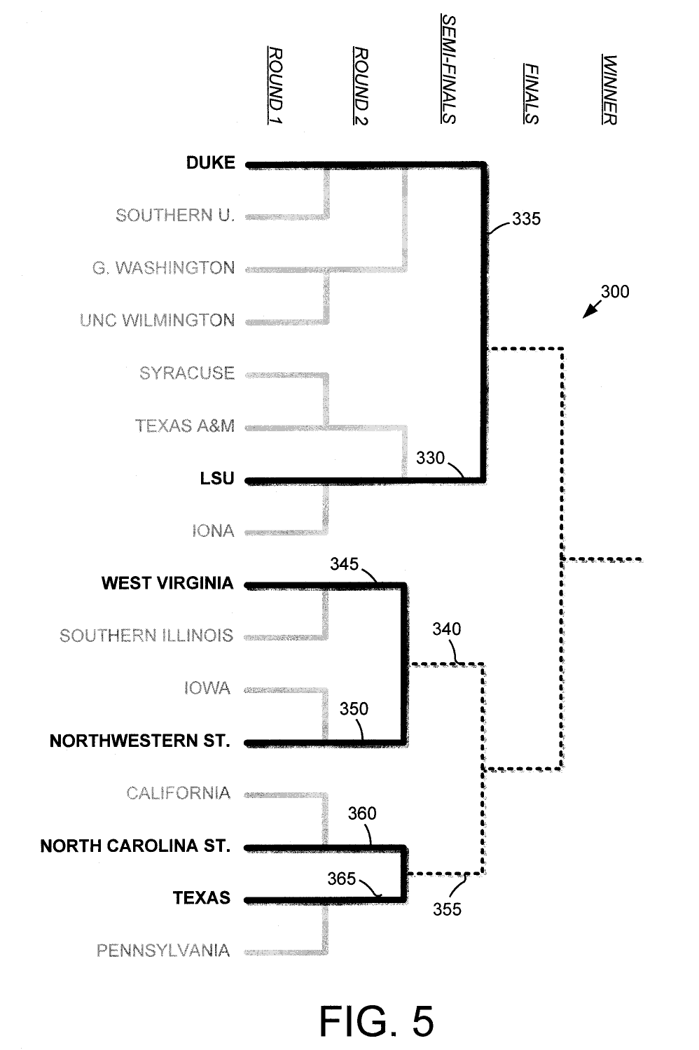

FIG. 5 illustrates an exemplary example of the tournament adaptive tree 300 shown in FIGS. 3 and 4 after a portion of Round 2 of the tournament has been completed. Again, as games are played the tournament adaptive tree 300 adapts or deforms itself to represent the state of the tournament. In this case, Duke's horizontal line 315 is extended into the Semi-Finals. In addition, because LSU won its game with Texas A&M, LSU's horizontal line 330 is extended into the Semi-Finals. Moreover, it can be seen from the solid, dark vertical line 335 that the Semi-Final round will include a game between Duke and LSU.

Note that the game between West Virginia and Northwestern St. and the game between North Carolina St. and Texas in Round 2 has not yet been played. This can be seen because the horizontal line 340 from the West Virginia/Northwestern St. game in Round 2 has not been assigned to either West Virginia's horizontal line 345 or to Northwestern St's horizontal line 350. Similarly, the horizontal line 355 from the North Carolina St./Texas game in Round 2 has not been assigned to either North Carolina St's horizontal line 360 or to Texas's horizontal line 365.

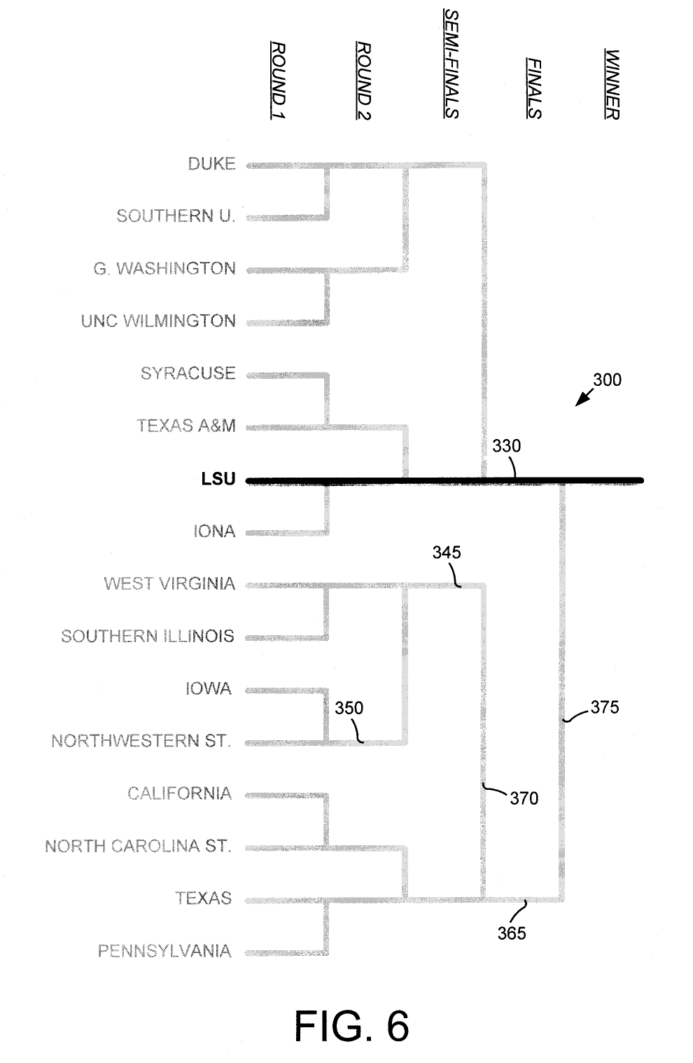

FIG. 6 illustrates an exemplary example of the tournament adaptive tree 300 shown in FIGS. 3-5 at the end of the tournament. It can be seen that West Virginia won the game in the Semi-Finals against Northwestern St. because West Virginia's horizontal line 345 extends into the Semi-Finals, while Northwestern St's horizontal line 350 stops in Round 2. Similarly, it can be seen that Texas won the game against North Carolina St. in the Semi-Finals because Texas's horizontal line 365 extends into the Semi-Finals, while North Carolina St's horizontal line 360 stops at Round 2. This means that West Virginia played Texas in the Semi-Finals, as shown by the vertical line 370 between West Virginia's horizontal line 345 and Texas's horizontal line 365. As can be seen by the fact that Texas's horizontal line 365 extends into the Finals, Texas won the game over West Virginia.

FIG. 6 also illustrates that the Finals included a game between LSU and Texas. This is indicated by LSU's horizontal line 330 and Texas's horizontal line 365 extending into the Finals. In addition, a vertical line 375 connecting LSU's horizontal line 330 and Texas's horizontal line 365 indicates that there is a game between these two teams in the Finals. The extension of LSU's horizontal line 330 into the Winner column indicates that LSU has won the game against Texas. This also is indicated by the graying out of all other lines and except for LSU's horizontal line 330. Moreover, it should be noted that each of the lines is solid and that there are no dotted lines remaining, meaning that there are no future games and all of the games of the tournament have been played.

As can be seen from the exemplary example shown in FIGS. 3-6, rather than repeating team names (as is done on a traditional bracket 100) to indicate wins in each match-up, the tournament adaptive tree 300 moves the horizontal result line indicating that two teams are playing a game to extend the horizontal line of the winning team. This means that each team's name appears only once (on one of the edges of the bracket) instead of multiple times. This means that a team's progress through the tournament is represented by a single, one-dimensional horizontal line extending from its name through the time periods of the tournament. When a team loses, the horizontal line terminates, since the continuation of the line in the next round moves to the winning team. In some embodiments, in order to make the visualization even clearer, the line and names of losing teams are grayed out. In other embodiments, games that have yet to be played are represented with a different line pattern (such as dotted lines).

A user viewing the tournament adaptive tree 300 is able to quickly see the games that have been played (represented by gray lines in FIGS. 3-6), the results of these games (each team has gotten to the round at which its horizontal line ends), all teams that have lost (team names are grayed out), teams that remain in the tournament (team names in black), the pending match-ups about to be played (teams connected by black lines), and future games in the tournament (dotted lines).

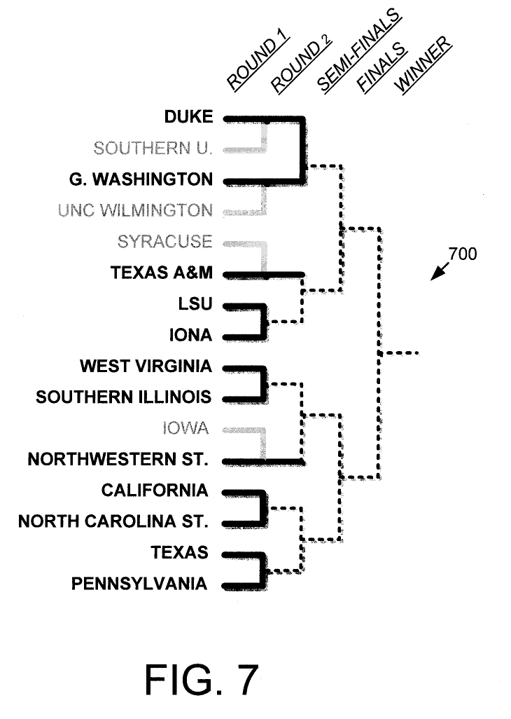

Since it is such a compact representation, the adaptive tree visualization system 200 works well even with very small amounts of space. FIG. 7 is a compact tournament adaptive tree 700, which is a compact version of the tournament adaptive tree 300 shown in FIGS. 3-6. As can be seen from FIG. 7, the compact adaptive tree 700 conveys the same information as the full-size adaptive tree 300 but in a smaller space. The compact adaptive tree 700 is useful for rendering on small monitors or video devices, such as smartphones or personal digital assistants (PDAs).

There are many alternative embodiments to the system 200. For example, some embodiments shrink the names of the losing teams to de-emphasize them, while other embodiments remove the losing team names altogether instead of graying them out. Some embodiments remove vertical lines and leave only the horizontal ones of past played games.

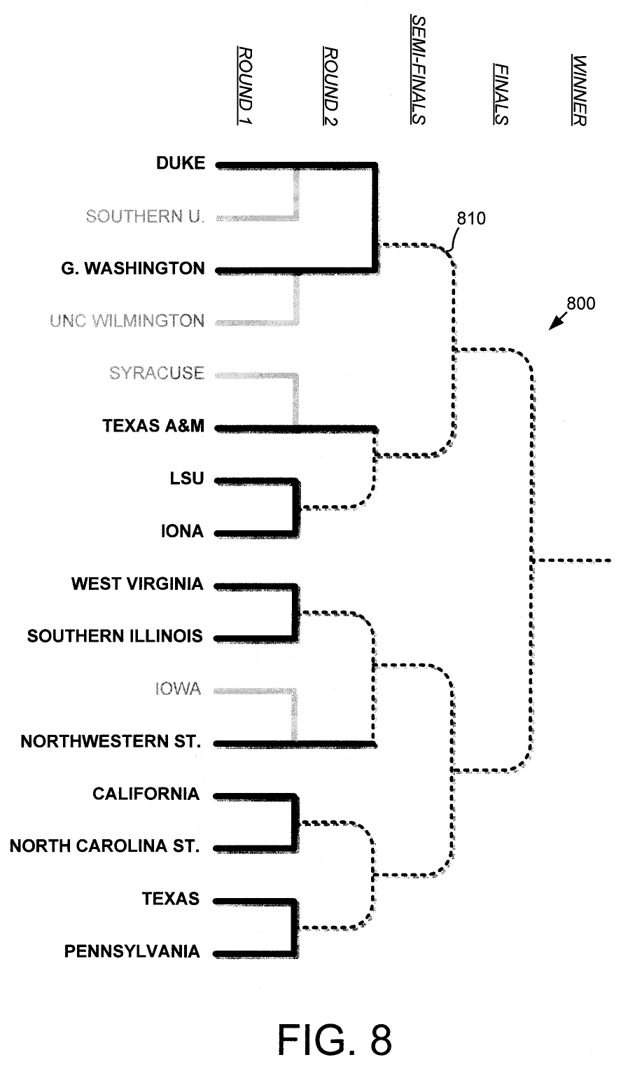

FIG. 8 illustrates an alternate embodiment of the tournament adaptive tree 300 shown in FIGS. 3-6. In this embodiment, an alternate tournament adaptive tree 800 represents unplayed games as dotted lines having rounded joints to further differentiate them from past and future games. By way of example, the game between the winner of the Duke/G. Washington game in Round 2 and the winner of the Texas A&M/LSU or Iona game is represented by a dotted line having round corner 810. The embodiment is another way to provide the user with a means to quickly scan the tree 800 for information about the tournament. Even with the various embodiments, the core idea of the adaptive tree visualization system 200 is maintained, such that the line from the center of the upcoming games deforms and creates horizontal result line from the team names. The horizontal lines represent the progress of individual teams.

### Overlays and Underlays

It is often desirable for peripheral information that augments the adaptive visualization tree system 200 to be seen in conjunction with the basic time and competitor information. There are several ways in which this peripheral information can be overlaid on the system 200.

Since information for each team is represented horizontally from each name, simple graphs can be overlaid on the system 200 to convey statistics for each team. In the sports tournament application, this could include statistics such as the likelihood of a team to reach various rounds in the tournament, or the percentage of users in an office pool that have picked a certain team to get to each of the rounds. In addition, text also can be overlaid on the system 200. For example, this is useful in sports brackets for showing the scores of past games or the location and time (or television channel) of future games. Additionally, text can be added off the edges of the visualization to label segments of the tree, such as for labeling the various regional divisions in sports brackets.

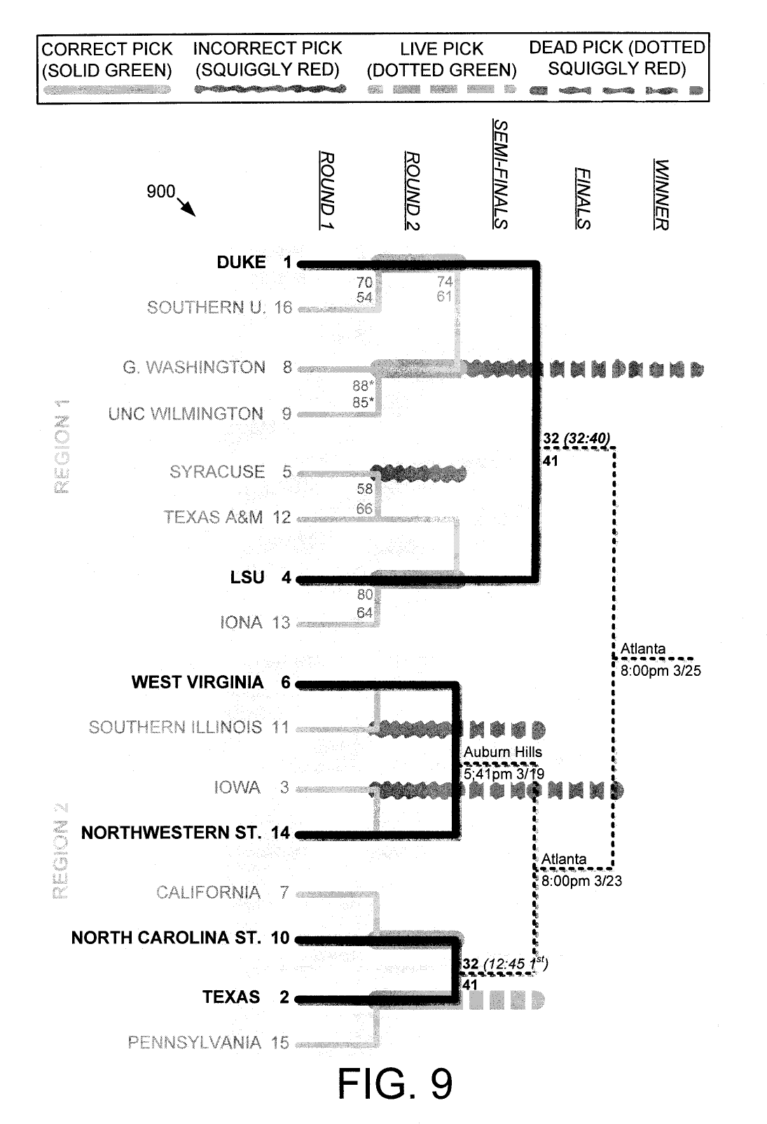

The tree 900 in FIG. 9 is visualizing a single player's picks, such as in a league. Typically, the way these leagues work is that each player makes a set of picks or predictions of who you think will win certain games during the course of the tournaments. When the tournament starts, the picks are in lockdown such that they cannot be changed anymore. Scoring is performed based on some scoring function, such as a point for each correct pick or a point for each correct pick in a given round. It is possible that the point schemes may be different for each round. Based on the scoring function, the winner of the league is the person who has the most points at the end of the tournament.

Referring to FIG. 9, overlaid on the original tournament adaptive tree are a single player's picks along with what has happened in the real world. In the example of FIG. 9, what has happened in the real world is shown in FIGS. 3-6. The line color, line shape, or both represent a player's picks. For example, in FIG. 9, this player has picked Duke to win Round 1. Moreover, this player has picked G. Washington to win the tournament, Syracuse and LSU to win in Round 1, Southern Illinois to win in Round 2, Iowa to win in Round 3, and so forth.

The color and shape coding in some embodiments is such that if the pick was correct it gets turned green (or a solid shape). If a pick is incorrect it gets turned red (or a squiggly shape). In some embodiments, a dotted green (or dotted-shaped) line and dotted red (or dotted squiggly) line is used to indicate that the game has not been played. The difference between the two is that the dotted green means that there is a potential of scoring and the dotted red means that there is no potential of scoring. A dotted green line means that there is a potential for scoring in these rounds but it is not guaranteed. For example, in FIG. 9, in the match-up between North Carolina St. and Texas, the player has picked Texas to win in the Semi-Finals (dotted green). It is dotted green because the player has the potential to score since Texas could win the game. If Texas wins, the line turns solid green, and if North Carolina St. wins, the line turns solid red. A dotted red line means the game or match-up will not be played in this tournament. In some embodiments the dotted red line is not used, only the solid red line. This is because the red dotted line is actually redundant encoding, because once something turns red it will always be red.

For example, in FIG. 9 at G. Washington vs. UNC Wilmington, instead of the horizontal line in the Semi-Finals column being a solid red and the horizontal line in the Finals and Winner columns being a dotted red, the line would be an all solid red. This indicates that the player got this pick wrong, and subsequent rounds will be wrong because G. Washington is no longer in the tournament.

In some embodiments, the green and red are redundantly encoded to account for color blindness of the viewer. Referring to FIG. 9, note that the shape of green and the shape of red are different, such that red looks like a squiggly line edge and green is a straight line edge. This accounts for red and green color blindness in the viewer.

This ability to do the line encoding is a side effect of the fact that the system 200 represents each team's progress in a straight line. This allows the viewer to compare line lengths and have the line length be a metric for how well a team is doing and how well a given player picked a team to do in the tournament. In FIG. 9, the G. Washington line sticks out the farthest for this player, meaning that this player picked G. Washington to win the tournament. But FIG. 9 also has a lot of red, which means that this player's particular picks will cost them a great deal of points in the standings (because the player picked G. Washington to win the tournament and instead they lost early in the tournament).

Pick information is only one set or type of information that can be overlaid on the adaptive tree visualization system 200. In other embodiments, other types of overlays and even underlays can be used to convey information. In FIG. 9, region information is underlaid. More specifically, on the far left side of FIG. 9 is a lightly shaded box is underlaid on the tree to indicate the various regions (“Region 1” and “Region 2”) to which each team belongs. Moreover, as shown in FIG. 9, additional information such as past scores, live scores, and the venue and times of future games can be overlaid or underlaid on the adaptive tree. Team ranking can be inserted next to the team names. Moreover, in some embodiments future games in which the player may be interested can be highlighted. For example, if there is a big local rivalry occurring in the future, text regarding the game can be highlighted, line color can be changed, or an icon can be used to call attention to this interesting information. This embodiment calls attention to interesting games that have not been played.

In some embodiments an overlay includes statistics about each of the teams, injury count, or the probability of a team winning. At the beginning of the tournament each team has a non-zero chance of winning. In this embodiment, the overlay includes a probability bar for each team that goes all the way to end, indicating that any team could win the tournament. But after each round, the probability bar would drop in saturation (or fade in color) depending on the likelihood of that team actually reaching the next round. Thus, the favorite teams in the tournament would have strong (or bright) bars all the way to the end of the tournament, but the teams that were expected to lose early would fade out quickly. In this embodiment, the overlay gives an overall sense of how the teams compare to one another as far as their chances of winning.

Because of the generic capability to overlay information on the adaptive tree visualization system 200, this allows us to visualize information that can quickly be assimilated by a viewer. This is a side effect of the one-dimensional, linear nature of the system 200, because each team's information can be overlaid to line up in a straight line with its name.

### III. Operation and Functionality

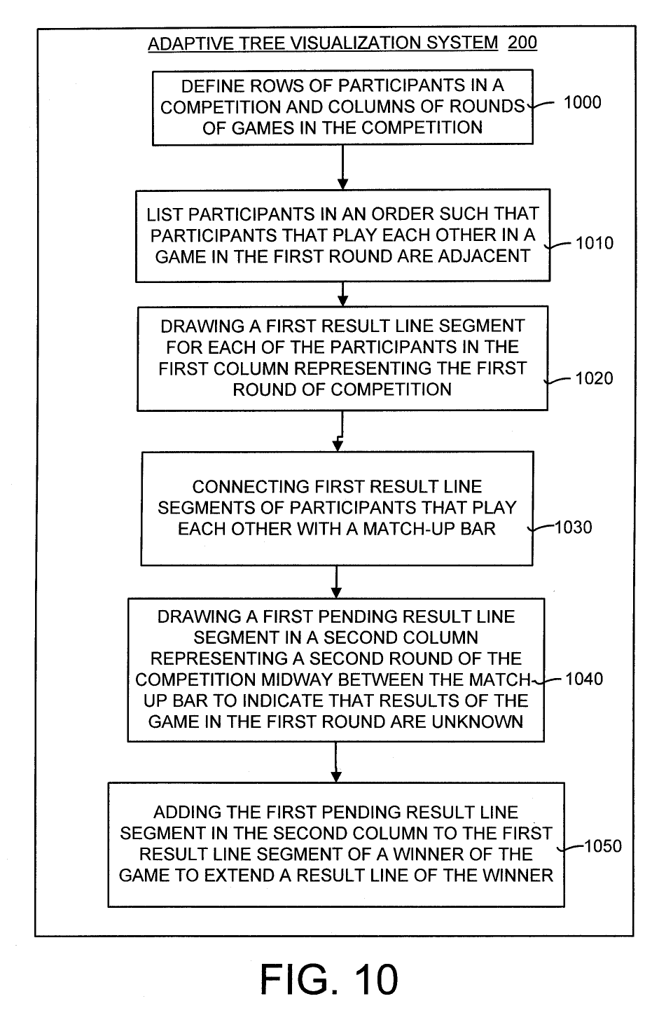

FIG. 10 is a flow diagram illustrating the general operation of the method used in the adaptive tree visualization system shown in FIGS. 2-9. In general, the adaptive tree visualization method takes the traditional bracket 100 and adaptively deforms the bracket 100 to convey results and other information about competitors in a linear fashion. The outcome and results information for each competitor can be quickly found by scanning in a straight line from the competitor's name.

More specifically, the method shown in FIG. 10 begins by defining rows of competitors in the competition and columns of rounds of match-ups in the competition (box 1000). The rows of competitors and the columns of rounds can be oriented in any direction (left to right, right to left, top to bottom, bottom to top). However, the rows and columns are orthogonal to each other. The rounds of match-ups represent match-ups or games that are played between competitors in a particular round of the competition. The competitors are listed in the first round in an order such that competitors that play each other in a game in the first round are adjacent to each other (box 1010).

The method next draws a first result line segment for each of the competitors in the first column, where the first column represents the first round of the competition (box 1020). The first result line segment goes across the first column and represents that each of the competitors are involved in the first round of competition. The first result line segments of competitors that play each other in the first round are connected by a match-up bar (box 1030).

The method then draws a first pending result line segment in the second column of the tree, where in the second column represents a second round of the competition (box 1040). This first pending result line segment is connected to each match-up bar halfway between the first result line segments of the competitors in a game. The first pending result line segment is used to indicate that the results of the game are unknown. This typically occurs when the game has not yet been played. There is a first pending result line segment for each game in the first round, and each of the subsequent rounds.

The first pending result line segment in the second column then is added to the first result line segment of each winner of games in the first round (box 1050). This has the effect of extending the first result line segment in the first column of the winner into the second column. In this case, each winner of a game in the first round has its first result line segment extended in length to include the first pending result line segment. The first pending result line segment then becomes part of the result line for that competitor. The losers of the games in the first round do not have their first result line segments extended, and they stop in the first round. This concept is followed in subsequent rounds of competition until all the games in all of the rounds have been played. Once the competition is finished, the winner is the competitor having the longest result line.

### Interactivity

There are various ways in which a user can interact with the adaptive tree visualization system 200. In some embodiments, a user may click on various information links within the system. When used in sports tournaments, this could bring up information about the team, the statistics from a particular game (past, present, or future), or it may link to other relevant information content.

Another scenario in which the user interacts with the system 200 is to manipulate content within the system 200 itself. For example, while it has been assumed that the information that is driving the visualization comes from a computer-based source, this may not always be the case. In the sports example, a player may wish to start with an empty bracket (one containing only the team names and structure, but no results) and make predictions on which teams they think will win. In this case there are several ways a user can do this. First, the user could click on the team name to indicate that the particular team wins a game. Hence, to get from FIG. 3 to FIG. 4 the user would click on the names Duke, G. Washington, Texas A&M, and Northwestern St. Then the user would click on Duke (a second time), LSU (twice), West Virginia, North Carolina St, and Texas, in order to get from FIG. 4 to FIG. 5. This can be continued in a similar manner until the entire bracket is filled out.

In other embodiments, an alternative method for selecting teams is to drag the team names into the bracket. For example, rather than clicking on a team twice in order to indicate that it wins two games, the user could just drag the team name past the second round to indicate that she thinks the team will win all games through the round in which the team was dropped. In some embodiments, the bracket is updated only when the drop is made. In other embodiments the bracket is updated interactively as the user moves the team through the various rounds. This provides real-time feedback on the action that will be performed if the user drops it at that given moment. If the updating is done in real-time, the lines will move up and down as the user drags and the drop target should be the entire column (from top to bottom) that represents the particular stage in the bracket. This is possible because the system 200 imposes the constraint of where a team can end up and there is no ambiguity so long as the stage in the bracket is well specified.

The drop target for the system 200 is different and easier than the traditional bracket 100. With the traditional bracket 100, the player must drag and drop team name on exactly the spot where the team would end up. With the system 200 disclosed herein, the player can drop the team name anywhere in the entire vertical column representing a round. This is because there is no ambiguity in the system 200. For example, referring to FIG. 9, if a player picks Duke to get to the semi-finals, the player can click on Duke and drag and drop anywhere in the vertical Semi-Final column. Even if the player drops the Duke tag horizontally out from Pennsylvania, there is no ambiguity and the system 200 will understand that the player has picked Duke to go to the semi-finals.

### Time Slider and Animation

Some embodiments of the adaptive tree visualization system 200 also include a “time slider” that allows the user to interactively scrub forwards and backwards through time. Since the shape of the tree evolves as more information is added, interactively inspecting the incremental (and in some embodiments, animated) visualization across time provides useful information that may help the user make sense of historical events. Information is changed on the tree as the user scrubs back and forth in time. In some embodiments these transitions are done in real time and the lines are animated.

### IV. Exemplary Operating Environment

The adaptive tree visualization system and method is designed to operate in a computing environment. The following discussion is intended to provide a brief, general description of a suitable computing environment in which the adaptive tree visualization system and method may be implemented.

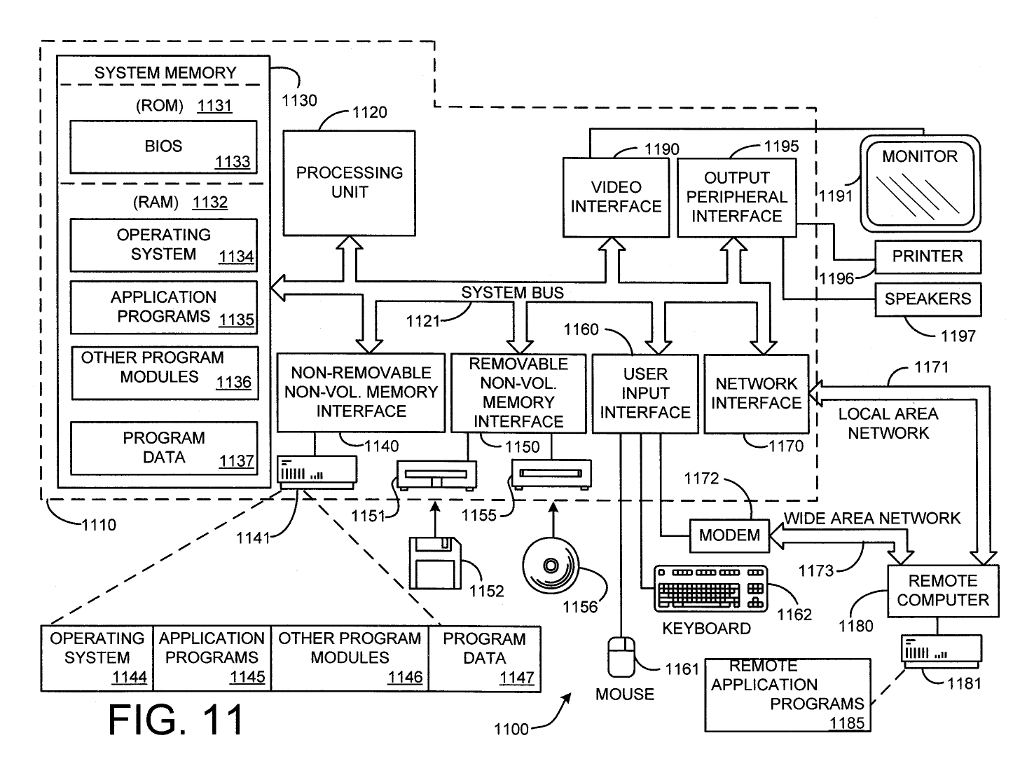

FIG. 11 illustrates an example of a suitable computing system environment in which the adaptive tree visualization system and method shown in FIGS. 2-10 may be implemented. The computing system environment 1100 is only one example of a suitable computing environment and is not intended to suggest any limitation as to the scope of use or functionality of the invention. Neither should the computing environment 1100 be interpreted as having any dependency or requirement relating to any one or combination of components illustrated in the exemplary operating environment.

The adaptive tree visualization system and method is operational with numerous other general purpose or special purpose computing system environments or configurations. Examples of well known computing systems, environments, and/or configurations that may be suitable for use with the adaptive tree visualization system and method include, but are not limited to, personal computers, server computers, hand-held (including smartphones), laptop or mobile computer or communications devices such as cell phones and PDA's, multiprocessor systems, microprocessor-based systems, set top boxes, programmable consumer electronics, network PCs, minicomputers, mainframe computers, distributed computing environments that include any of the above systems or devices, and the like.

The adaptive tree visualization system and method may be described in the general context of computer-executable instructions, such as program modules, being executed by a computer. Generally, program modules include routines, programs, objects, components, data structures, etc., that perform particular tasks or implement particular abstract data types. The adaptive tree visualization system and method may also be practiced in distributed computing environments where tasks are performed by remote processing devices that are linked through a communications network. In a distributed computing environment, program modules may be located in both local and remote computer storage media including memory storage devices. With reference to FIG. 11, an exemplary system for the adaptive tree visualization system and method includes a general-purpose computing device in the form of a computer 1110.

Components of the computer 1110 may include, but are not limited to, a processing unit 1120 (such as a central processing unit, CPU), a system memory 1130, and a system bus 1121 that couples various system components including the system memory to the processing unit 1120. The system bus 1121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 1110 typically includes a variety of computer readable media. Computer readable media can be any available media that can be accessed by the computer 1110 and includes both volatile and nonvolatile media, removable and non-removable media. By way of example, and not limitation, computer readable media may comprise computer storage media and communication media. Computer storage media includes volatile and nonvolatile removable and non-removable media implemented in any method or technology for storage of information such as computer readable instructions, data structures, program modules or other data.

Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computer 1110. Communication media typically embodies computer readable instructions, data structures, program modules or other data in a modulated data signal such as a carrier wave or other transport mechanism and includes any information delivery media.

Note that the term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 1140 includes computer storage media in the form of volatile and/or nonvolatile memory such as read only memory (ROM) 1131 and random access memory (RAM) 1132. A basic input/output system 1133 (BIOS), containing the basic routines that help to transfer information between elements within the computer 1110, such as during start-up, is typically stored in ROM 1131. RAM 1132 typically contains data and/or program modules that are immediately accessible to and/or presently being operated on by processing unit 1120. By way of example, and not limitation, FIG. 11 illustrates operating system 1134, application programs 1135, other program modules 1136, and program data 1137.

The computer 1110 may also include other removable/non-removable, volatile/nonvolatile computer storage media. By way of example only, FIG. 11 illustrates a hard disk drive 1141 that reads from or writes to non-removable, nonvolatile magnetic media, a magnetic disk drive 1151 that reads from or writes to a removable, nonvolatile magnetic disk 1152, and an optical disk drive 1155 that reads from or writes to a removable, nonvolatile optical disk 1156 such as a CD ROM or other optical media.

Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 1141 is typically connected to the system bus 1121 through a non-removable memory interface such as interface 1140, and magnetic disk drive 1151 and optical disk drive 1155 are typically connected to the system bus 1121 by a removable memory interface, such as interface 1150.

The drives and their associated computer storage media discussed above and illustrated in FIG. 11, provide storage of computer readable instructions, data structures, program modules and other data for the computer 1110. In FIG. 11, for example, hard disk drive 1141 is illustrated as storing operating system 1144, application programs 1145, other program modules 1146, and program data 1147. Note that these components can either be the same as or different from operating system 1134, application programs 1135, other program modules 1136, and program data 1137. Operating system 1144, application programs 1145, other program modules 1146, and program data 1147 are given different numbers here to illustrate that, at a minimum, they are different copies. A user may enter commands and information (or data) into the computer 1110 through input devices such as a keyboard 1162, pointing device 1161, commonly referred to as a mouse, trackball or touch pad, and a touch panel or touch screen (not shown).

Other input devices (not shown) may include a microphone, joystick, game pad, satellite dish, scanner, radio receiver, or a television or broadcast video receiver, or the like. These and other input devices are often connected to the processing unit 1120 through a user input interface 1160 that is coupled to the system bus 1121, but may be connected by other interface and bus structures, such as, for example, a parallel port, game port or a universal serial bus (USB). A monitor 1191 or other type of display device is also connected to the system bus 1121 via an interface, such as a video interface 1190. In addition to the monitor, computers may also include other peripheral output devices such as speakers 1197 and printer 1196, which may be connected through an output peripheral interface 1195.

The computer 1110 may operate in a networked environment using logical connections to one or more remote computers, such as a remote computer 1180. The remote computer 1180 may be a personal computer, a server, a router, a network PC, a peer device or other common network node, and typically includes many or all of the elements described above relative to the computer 1110, although only a memory storage device 1181 has been illustrated in FIG. 11. The logical connections depicted in FIG. 11 include a local area network (LAN) 1171 and a wide area network (WAN) 1173, but may also include other networks. Such networking environments are commonplace in offices, enterprise-wide computer networks, intranets and the Internet.

When used in a LAN networking environment, the computer 1110 is connected to the LAN 1171 through a network interface or adapter 1170. When used in a WAN networking environment, the computer 1110 typically includes a modem 1172 or other means for establishing communications over the WAN 1173, such as the Internet. The modem 1172, which may be internal or external, may be connected to the system bus 1121 via the user input interface 1160, or other appropriate mechanism. In a networked environment, program modules depicted relative to the computer 1110, or portions thereof, may be stored in the remote memory storage device. By way of example, and not limitation, FIG. 11 illustrates remote application programs 1185 as residing on memory device 1181. It will be appreciated that the network connections shown are exemplary and other means of establishing a communications link between the computers may be used.

The foregoing Detailed Description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. An adaptive tree visualization system for representing changes over time of constituents of the system, comprising:
a time component in a first direction having a column for each of a plurality of discrete time periods in an event;
a constituent component in a second direction that is orthogonal to the first direction that lists n constituents in rows as n inputs to the system; and
a one-dimensional result line for each of the n constituents oriented in the first direction across the columns in each of the rows that indicates by a length of the result line which of the n constituents are also m outputs of the system, such that n>m.

2. The adaptive tree visualization system of claim 1, further comprising the n constituents listed in a first column in an order such that a comparison is performed between pairs of adjacent constituents during a first time period of the plurality of discrete time periods of the event, such that the first column represents the first time period.

3. The adaptive tree visualization system of claim 2, further comprising a match-up bar oriented in the second direction connecting a result line segment_{1,1}, and a result line segment_{2,1} to indicate that the comparison is performed between the first constituent and the second constituent during the first time period, such that for a result line segment_{x,y} x represents a constituent number and y represents a column number, such that results line segment_{1,1}, means the result line segment for the first constituent of the n constituents located in the first column.

4. The adaptive tree visualization system of claim 3, further comprising a first pending result line segment oriented in the first direction in a second column and located midpoint on the match-up bar between the result line segment_{1,1} and the result line segment_{2,1}, such that the second column represents a second time period.

5. The adaptive tree visualization system of claim 4, such that the first pending result line segment has a different line pattern than the result line segment_{1,1} and the second result line segment_{2,1}.

6. The adaptive tree visualization system of claim 4, further comprising:
a result line segment_{1,2} added to the result line segment_{1,1} if the comparison during the first time period was in favor of the first constituent; and
a result line segment_{2,2} added to the result line segment_{2,1} if the comparison during the first time period was in favor of the second constituent.

7. The adaptive tree visualization system of claim 6, such that the result line segment_{1,2} has the same line pattern as result line segment_{1,1} and the result line segment_{2,2} has the same line pattern as the result line segment_{2,1}.

8. The adaptive tree visualization system of claim 7, such that the line pattern further comprises a line color, a line thickness, a line boldness, and a line type.

9. The adaptive tree visualization system of claim 7, such that the event is a tournament, the n constituents are competitors in the tournament, and the comparison is a game between two of the n constituents.

10. The adaptive tree visualization system of claim 9, wherein m=1 such that there is one winner of the tournament.

11. An adaptive tree for visualizing future match-ups and results of the match-ups in a tournament having a plurality of match-ups, comprising:
competitors in the tournament listed in rows of the tree;
rounds of the tournament listed in columns of the tree; and
a straight result line across each competitor's row such that a length of the result line represents results of each match-up in each round for a competitor and represents a competitor's progress in the tournament.

12. The adaptive tree of claim 11, further comprising:
a match-up bar in a first round column that connects a first competitor's result line segment in a first round column to a second competitor's result line segment in the first round column that represents that a match-up will occur between the first competitor and the second competitor during the first round of the tournament; and
a first pending result line segment in a second round column halfway between the first competitor's result line segment in the first round column and the second competitor's result line segment in the first round column on the match-up bar that represents that an outcome of the match-up between the first competitor and the second competitor is not yet known.

13. The adaptive tree of claim 12, further comprising a second-round result line segment that is connected to a result line segment in the first round column of a winner of the match-up between the first competitor and the second competitor such that the first pending result line segment in the first round column is added to the winner's result line segment in the first round column to extend the winner's result line segment in the first round column to the second round column.

14. The adaptive tree of claim 13, such that the first pending result line segment further comprises a different line boldness, line color, line type, or line thickness than the first competitor's result line segment in the first round column and the second competitor's result line segment in the first round columns to indicate that the outcome of the match-up between the first competitor and the second competitor is unknown.

15. The adaptive tree of claim 13, further comprising an underlay that is located under the adaptive tree to represent a player's picks of which competitors will win certain match-ups during the course of the tournament, such that lines of the underlay are thicker than other lines on the adaptive tree to better visualize the player's picks, and such that the player's picks for each competitor are located in a straight line along a row in which the competitor is listed.

16. The adaptive tree of claim 15, such that the lines of the underlay are dual coded by line color, line shape, and line type such that correct and incorrect picks of the player are represented by different line colors, line shapes, and line types.

17. A method for adapting a shape of a tournament bracket tree to visualize results from a competition, comprising:
defining rows of competitors in the competition and columns of rounds of match-ups from the competition, such that each competitor is listed in its own row;
listing each competitor in an order such that competitors that play each other in a game in the first round are adjacent;
drawing a first result line segment for each of the competitors in the first column representing the first round of the competition;
connecting first result line segments of competitors that play each other in the game in the first round using a match-up bar;
drawing a first pending result line in a second column representing a second round of the competition midway between the match-up bar to indicate that results of the game in the first round are unknown; and
adding the first pending result line segment in the second column to the first result line segment of a winner of the game to extend a result line of the winner.

18. The method of claim 17, adding a pending result line in a round to a winner of a game in that round after each game such that a winner's result line is extended to the next round and the loser's result line stops at that round.

19. The method of claim 18, further comprising identifying a winner of the competition after game in all rounds have been played by locating a competitor having a longest result line across a row containing a name of a winning competitor.

20. The method of claim 19, further comprising:
identifying a player's picks on the tree that represent who the player picked to win games in each round and who the player picked to win the competition, such that a player's picks for each competitor are in a straight line across a row listing the competitor's name; and
overlaying information about the competitor in the row listing the competitor's name.
